(19) United States
(12) Patent Application Publication
(10) Pub. No.: US 2014/0287123 A1
(43) Pub. Date: Sep. 25, 2014

(54) SUGAR CONFECTIONARY PRODUCT ON THE BASIS OF A GELATIN GEL AND METHOD FOR ITS PRODUCTION

(71) Applicant: GELITA AG, Eberbach (DE)

(72) Inventors: Eberhard DICK, Neckargemund (DE); Simone WALTER, Wald-Michelbach (DE)

(73) Assignee: GELITA AG, Eberbach (DE)

(21) Appl. No.: 14/294,765

(22) Filed: Jun. 3, 2014

Related U.S. Application Data
(63) Continuation of application No. PCT/EP2012/074436, filed on Dec. 5, 2012.

(30) Foreign Application Priority Data
Dec. 5, 2011 (DE) 10 2011 056 018.1

(51) Int. Cl. A23G 3/44

(52) U.S. Cl. CPC A23G 3/44
USPC 426/571; 426/660

(57) ABSTRACT

The present invention relates to a sugar confectionary product on the basis of a gelatin gel, comprising approximately 1% to approximately 15% by weight of gelatin, and approximately 20% to approximately 85% by weight of at least one sugar and/or sugar substitute. In order to increase the melting point of the gelatin gel, it is proposed that the sugar confectionary product contains one or more polyphenols.

### CROSS REFERENCE TO RELATED APPLICATIONS

This patent application is a continuation of International Application Number PCT/EP2012/074436, filed Dec. 5, 2012, which claims the benefit of German application DE 10 2011 056 018.1, filed Dec. 5, 2011, which are each incorporated by reference.

### BACKGROUND OF THE INVENTION

The present invention relates to a sugar confectionary product on the basis of a gelatin gel, comprising approximately 1% to approximately 15% by weight, preferably approximately 1% to approximately 7.5% by weight of gelatin and approximately 20% to approximately 85% by weight of at least one sugar and/or sugar substitute.

The invention also relates to a method for producing a sugar confectionary product of this type.

Sugar confectionary products, which are produced on the basis of a gelatin gel include, for example, gum sweets (especially well known in the form of jelly babies) and marshmallows (in which the gelatin gel is foamed with air). For the manufacturing of confectionary products of this type, gelatin, that is, partially hydrolysed collagen from animal connective tissue is dissolved at a raised temperature of, for example, 60° C., from which a homogeneous colloidal solution is obtained which, on cooling, sets into a relatively solid gelatin gel. This process is reversible, that is, sugar confectionary products of this type melt above a particular temperature which typically lies in the region of 40° C. to 45° C.

This relatively low melting point presents a significant problem for the supply of sugar confectionary products in regions where correspondingly high temperatures prevail either all year or seasonally because the products adhere to one another and/or to the packaging and/or lose their pre-defined shape as they melt, and are thus unsaleable. Under such conditions, these sugar confectionary products must therefore be cooled, which entails significant additional costs, in particular during transport. This can have the effect that the supply of sugar confectionary products based on gelatin becomes completely uneconomic in hot regions.

Alternative sugar confectionary products with higher melting points are known which are produced based on hydrocolloids of plant origin such as pectin, agar, gellan or starch, rather than on gelatin. However, these products have marked sensory differences from products based on gelatin (e.g. adhering to the teeth or too short a bite) and are therefore rejected by many consumers.

With regard to gelatin, it is known in principle that the melting point of the gel can be raised by cross-linking the gelatin, that is, by chemical linking of the individual gelatin molecules. However, the cross-linking agents that are typically used for this (e.g. chemical cross-linking agents such as formaldehyde and glutaraldehyde or enzymes such as transglutaminase) are either not authorised for food use or are unsuitable for the production of sugar confectionary products. The use of many chemical cross-linking agents is precluded purely by reason of their being hazardous to health.

### BRIEF SUMMARY OF THE INVENTION

It is therefore an object of the invention to make available a sugar confectionary product on the basis of a gelatin gel with an increased melting point.

This object is achieved with the sugar confectionary product of the type mentioned in the introduction in that the sugar confectionary product contains one or more polyphenols.

### DETAILED DESCRIPTION OF THE INVENTION

Polyphenols occur in a variety of plants and belong to the secondary phytochemicals. By reason of their chemical structure, these compounds are characterised in that they contain one or more aromatic ring structures, wherein two or more hydroxyl groups are directly bound to an aromatic ring. It has been found that polyphenols bring about cross-linking of the gelatin so that a gelatin gel containing a polyphenol has a higher melting point than a corresponding gelatin gel without polyphenols.

This effect also has the result that the sugar confectionary products produced by moulding the gelatin solution become solid faster during cooling due to the addition of polyphenol, that is, the production process can be shortened, which is economically advantageous. During the production of foamed products such as marshmallows, a more rapid gelation has a generally advantageous effect on the production process because the foam structure formed can thereby be better stabilised.

A further advantageous effect resulting from the cross-linking of the gelatin with polyphenols is an increase in the solidity of the gelatin gel formed, i.e. in order to the achieve a pre-determined solidity, the proportion of gelatin can be reduced, which results in a reduction of costs.

The polyphenol or polyphenols can be obtained from plant extracts and/or the sugar confectionary product can contain the polyphenol or polyphenols as a component of one or more plant extracts. According to one embodiment, the polyphenols can thus be used as defined compounds in an isolated form, provided they are suitably available. However, in general, it is simpler and more economical to use plant extracts which contain one or more polyphenols, possibly together with further components. Provided the relevant plants are authorised as foods, in any case no barriers exist to the use in the context of the present invention of the extracts or of polyphenols isolated therefrom.

Of significance for the effects of the polyphenols on the melting point of the gelatin gel is, in particular, the quantity used in relation to the quantity of gelatin. It has proved to be advantageous if the sugar confectionary product contains at least 0.05% by weight, preferably at least 0.1% by weight, and more preferably at least 0.5% by weight of one or more polyphenol-containing plant extracts relative to the quantity of gelatin, wherein an extract is always understood herein to mean a dry extract. It has been found that a melting point increase can be achieved even with relatively small quantities of polyphenol, whereas above a particular quantity of polyphenol, a further addition no longer leads to a significant increase. As an upper limit, the sugar confectionary product typically contains up to 10% by weight, preferably up to 5% by weight, and more preferably up to 2.5% by weight of one or more polyphenol-containing plant extracts relative to the quantity of gelatin.

The plant extract or extracts is/are preferably selected from tea extract, grape extract, oak bark extract, cocoa extract or mixtures thereof. Suitable extracts which contain a high proportion of polyphenols are commercially available and are already used in foods. Naturally, further plant extracts can be used, provided they are allowable under food laws. Preferred plant extracts have a polyphenol content of 60% or more by weight, in particular also 90% or more by weight.

The polyphenol or polyphenols is/are preferably selected from tannins, catechins, anthocyanins and quercetin, which are contained in the aforementioned plant extracts. In general, a cross-linking effect on gelatin can be assumed for all polyphenols.

The addition of one or more polyphenols to the sugar confectionary products according to the invention leads, as described, to an increase in the melting point of the gelatin gel (and to an increased hardness), wherein the precise melting point is also naturally dependent on the remaining composition of the sugar confectionary product. Typically, the melting point of the gelatin gel in the sugar confectionary product according to the invention is above 40° C., preferably above 45° C. and more preferably above 50° C. it should be noted in this regard that in practice a melting point increase by a few degrees can be significantly advantageous.

According to the invention, the sugar confectionary product comprises at least one sugar and/or sugar substitute. The at least one sugar is preferably selected from sucrose, glucose, fructose, glucose syrup and mixtures thereof. Sugar alcohols, for example, sorbitol, mannitol or maltitol, in particular, can be used as sugar substitutes for calorie-reduced sugar confectionary products.

In addition to gelatin, sugar, sugar substitutes and polyphenols, the sugar confectionary product according to the invention can contain further constituents which are known from the prior art, in particular flavourings, colouring agents and/or edible acids.

The sugar confectionary product is preferably selected from the group consisting of gum sweets, marshmallows, chewing sweets, pastilles and liquorice, these products differing in their precise composition and/or form. The proportion of gelatin in the sugar confectionary products according to the invention is approximately 1% to approximately 15% by weight, preferably approximately 1% to approximately 7.5% by weight, in particular approximately 3.5% to 6.5% by weight (e.g. in the case of gum sweets). The proportion of sugar and/or sugar substitutes can vary, depending on the desired taste, within a wide range from approximately 20% to approximately 85% by weight.

It is a further object of the invention to provide a method for producing the sugar confectionary product described above.

This object is achieved with the method of the type mentioned in the introduction by means of the following steps:
producing a first aqueous solution which contains the gelatin and optionally the at least one sugar and/or sugar substitute;
producing a second aqueous solution which contains the polyphenol or polyphenols and optionally the at least one sugar and/or sugar substitute;
mixing the first and the second aqueous solutions at a temperature between approximately 60° C. and approximately 90° C., in order to obtain a moulding solution; and
moulding or extruding the moulding solution into a hollow mould which defines the shape of the sugar confectionary product.

The method according to the invention proposes the provision of the gelatin and the polyphenol or polyphenols in the form of separate aqueous solutions and only combining them into one moulding solution immediately before or during the moulding or extrusion. By this means, the premature onset in the moulding solution of cross-linking of the gelatin by the polyphenols, which would impair workability, can be prevented.

It is particularly advantageous if mixing of the first and second aqueous solutions is performed by means of a static mixer through which a pre-determined quantity of both solutions is fed so that the mixed moulding solution can be transferred from the static mixer directly into the hollow mould (using so-called “one shot technology”). Excessive local concentrations of polyphenol, which would result in precipitation of the gelatin and thus to undesirable clouding of the sugar confectionary products can be prevented by effective mixing.

The at least one sugar and/or sugar substitute is preferably contained in the second aqueous solution, along with any other ingredients (e.g. flavourings and colourings), i.e. in this case, the second aqueous solution contains all the constituents of the sugar confectionary product with the exception of the gelatin.

The first and second aqueous solutions are favourably mixed in a ratio of approximately 1:1 to approximately 100:1, i.e. the gelatin-containing first aqueous solution is diluted during the mixing process by only a maximum of 50%. Otherwise, a substantially higher gelatin concentration would have to be employed in the first aqueous solution than in the confectionary to be produced, which could potentially be problematic. By contrast with this, the production of the second aqueous solution is generally not problematic, even with a very high starting concentration of polyphenols and possibly sugars and/or sugar substitutes. However, particularly favourable is a mixing ratio between the first and the second aqueous solution of approximately 1:1 to approximately 50:1, more preferably approximately 1:1 to approximately 10:1, since a relatively high concentration of polyphenol in the second aqueous solution, as is required for very unequal mixing ratios, can potentially lead to the precipitation of gelatin during mixing, due to high local polyphenol concentrations.

The first aqueous solution preferably contains approximately 1% to approximately 20% by weight of gelatin, more preferably approximately 2% to approximately 15% by weight.

The second aqueous solution preferably contains approximately 0.5% to approximately 25% by weight of one or more polyphenol-containing plant extracts. Alternatively, the second aqueous solution can also contain a corresponding quantity of one or more isolated polyphenols.

In one embodiment of the invention, the moulding solution is foamed before and/or during the moulding. In this way, marshmallows or other foamed sugar confectionary products can be produced.

These and other advantages of the invention will now be described in greater detail based on the following examples.

### EXAMPLE 1

In this example, the increase in the melting point of a gelatin gel was investigated by means of the addition of various polyphenol-containing plant extracts.

The plant extracts used are the grape extract OmniVin 20R, the oak bark extracts Tanal 02 and Tanal 04 and the cocoa extract OmniCoa 55, which are each sold by the firm of Ajinmoto OmniChem in Belgium, and a green tea extract and a tea extract from the firm of Plantextrakt (MB-Holding GmbH & Co, KG),

A first aqueous solution, the composition of which corresponds to a normal cooking mixture for gum sweets, was produced from the following constituents with the proportions by weight as given in each case:

Components A:

| | |
|---|---|
| Sucrose | 28.20% by weight |
| Glucose syrup, 44 DE (dextrose equivalents) | 37.60% by weight |
| Sorbitol syrup (70% by weight) | 6.60% by weight |
| Water | 4.70% by weight |

Components B:

| | |
|---|---|
| Gelatin, type A (260 g Bloom) | 7.00% by weight |
| Water | 14.00% by weight |

Component C:

| | |
|---|---|
| Citric acid (50% solution by weight) | 1.90% by weight |

Components A were mixed, boiled down to a dry substance content of 87% by weight and subsequently cooled to 90° C. Components B were dissolved at 60° C. Components B and C were added sequentially to components A and a homogeneous mixture was produced.

For a comparison sample without polyphenols, this first aqueous solution was used without further ingredients, as a moulding solution.

For the samples containing polyphenol, second aqueous solutions were prepared from each of the above-mentioned plant extracts, by firstly making 10% by weight solutions of the extracts in water and then mixing these in a 1:1 ratio with a DE 60 glucose syrup.

Thus, the first aqueous solution contains 7% by weight of gelatin and the second aqueous solutions each contain 5% by weight of polyphenol-containing plant extract.

In order to produce sugar confectionary products (gum sweets), the first and the second aqueous solutions were mixed in a ratio of 9:1 and this mixture was then poured into hollow moulds formed in a powder bed of dry starch. The moulding solution was sprinkled with starch and left to set and dry at room temperature for 48 hours. The weight of the gum sweets produced was between 2.5 g and 3 g.

The quantity of plant extract in this case was 7.9% by weight, relative to the quantity of gelatin.

The melting points determined for the gelatin gels of the sugar confectionary products manufactured in this way are shown in Table 1 below:

TABLE 1

| Plant extract | Melting point |
|---|---|
| Comparison sample | 45.9° C. |
| without plant extract | |
| OmniVin 20R | 51.3° C. |
| Tanal 02 | 48.1° C. |
| Tanal 04 | 46.3° C. |
| OmniCoa 55 | 48.7° C. |
| Green tea extract | 48.3° C. |
| Tea extract | 48.6° C. |

It was found that all the plant extracts used resulted in an increase in the melting point, the increase for almost all the extracts (except Tanal 04) being more than 2° C. and, in the case of OmniVin 20R, very marked at more than 5° C.

The colour of the moulding solutions and of the gum sweets produced varies depending on the plant extract, from light yellow and orange to dark red, the moulding solution remaining very clear in all cases after mixing of the first and second aqueous solutions and only in the case of the green tea extract and the tea extract did a slight clouding occur on the surface.

### EXAMPLE 2

In this example, the properties of a gum sweet produced using the plant extract Tanal 04 were examined more closely in comparison with a gum sweet without polyphenols.

The first gelatin-containing aqueous solution (cooking mixture) and the second plant extract-containing aqueous solution were produced according to Example 1. However, the mixing ratio for producing the moulding solution in this case was 39:1, that is, a significantly smaller quantity of Tanal 04 was used (1.83% by weight relative to the quantity of gelatin).

The melting points of the comparison sample and the polyphenol-containing sample were determined immediately following the production of the gum sweets (as in Example 1) and after storage of the gum sweets for six weeks. The results are shown in Table 2 below:

TABLE 2

| | Melting point after | Melting point after |
|---|---|---|
| Plant extract | production | six weeks |
| Comparison sample | 44.9° C. | 44.9° C. |
| without plant extract | | |
| Tanal 04 | 45.9° C. | 51.4° C. |

It was found that the relatively low melting point increase by 1° C. immediately after the production of the gum sweets (that is, after the 48 hour drying time) rose over the period of six weeks to give a very significant increase of 6.5° C. This indicates that the cross-linking reaction between the gelatin and the polyphenols continues during this period.

Furthermore, the gel hardness of the gum sweets was measured according to the Bloom standard method, and the results are shown in Table 3 below (average values of two measurements, in each case):

TABLE 3

| | Gel hardness after | Gel hardness after |
|---|---|---|
| Plant extract | production | six weeks |
| Comparison sample | 644 g | 741 g |
| without plant extract | | |
| Tanal 04 | 671 g | 935 g |

The gel hardness increased during the six-week storage period in the case also of the comparison sample (by approximately 15%), although the hardness increase in the polyphenol-containing sample is markedly more significant at approximately 40%. The increasing cross-linking of the gelatin, apart from increasing the melting point, therefore also leads to a marked increase in the gel hardness.

### EXAMPLE 3

In this example, the kinetics of increasing the melting point in a gum sweet made according to Example 2 was investigated over a period of 28 days after production (plant extract Tanal 04 as compared with a comparison sample without polyphenols).

The results are shown in Table 4 below:

TABLE 4

| Days after | Melting point | Melting point with |
|---|---|---|
| production | Comparison sample | Tanal 04 |
| 0 | 44.9° C. | 45.0° C. |
| 2 | 44.8° C. | 45.1° C. |
| 4 | 44.8° C. | 47.1° C. |
| 9 | 45.2° C. | 49.3° C. |
| 11 | 44.8° C. | 49.4° C. |
| 12 | 45.0° C. | 49.6° C. |
| 14 | 45.2° C. | 50.4° C. |
| 17 | 47.0° C. | 49.9° C. |
| 21 | 44.9° C. | 49.7° C. |
| 24 | 44.8° C. | 50.1° C. |
| 28 | 44.8° C. | 50.4° C. |

Whilst the melting point of the comparison sample remains essentially constant, in the polyphenol-containing sample, initially a continuous increase was observed and from approximately 10 days after production of the gum sweets only insignificant changes were observed. In the long term, also, a melting point increase by about 5° C. took place, due to the cross-linking of the gelatine gel by polyphenols.

### EXAMPLE 4

In this example, gum sweets were also produced with the plant extract Tanal 04, though according to a production method modified from that of Examples 1 to 3 and the melting point and gel hardness was determined relative to a comparison sample.

In this case, the first aqueous solution contained exclusively the gelatin, which was dissolved in water in a concentration of 7% by weight at 60° C. The second aqueous solution contained all the remaining constituents and was produced by mixing 97.38% by weight of a cooking mixture of components A and C according to Example 1 and 2.62% by weight of a 25% by weight aqueous solution of the plant extract Tanal 04.

The moulding solution was made by mixing the first and second aqueous solutions in the ratio of 4:1, so that a resulting content of plant extract of 2.34% by weight relative to the quantity of gelatin was the result.

The moulding of the gum sweets was carried out as described in Example 1.

The melting points of the gum sweets immediately after production and after storage for six weeks are shown in Table 5 below:

TABLE 5

| | Melting point after | Meeting point after |
|---|---|---|
| Plant extract | production | six weeks |
| Comparison sample | 46.5° C. | 44.2° C. |
| without plant extract | | |
| Tanal 04 | 46.5° C. | 51.7° C. |

In this case also, there was a significant increase in the melting point, of approximately 5° C., due to the polyphenol-containing plant extract, although only after the storage period of six weeks.

The measured gel hardness values (average values taken from two measurements) are shown in Table 6 below:

TABLE 6

| | Gel hardness after | Gel hardness after |
|---|---|---|
| Plant extract | production | six weeks |
| Comparison sample | 468 g | 617 g |
| without plant extract | | |
| Tanal 04 | 523 g | 791 g |

Even though the hardness values were generally lower in this case than for gum sweets produced according to the method of Example 2, in this case also, it was found that the gel hardness of the gelatin gel cross-linked with Tanal 04 increased more strongly during the six-week storage period than with the gelatin gel according to the comparison sample.

### EXAMPLE 5

In this example, it was determined how, in the presence of polyphenols, a reduction in the proportion of gelatin in the sugar confectionary product affects the melting point and the gel hardness of the gelatin gel.

The production of the gum sweets was carried out as described in Example 2, that is, the first gelatin-containing aqueous solution was mixed in a ratio of 39:1 with the second aqueous solution containing the plant extract Tanal 04. The composition of the first aqueous solution exactly corresponded, in one sample, to Example 2 (relative gelatin content 100%) and in three further samples, the gelatin content was reduced in proportion thereto to 85%, 75% and 65%, respectively.

The melting points and gel hardness values of the gum sweets measured 14 days after their production are shown in Table 7 below:

TABLE 7

| | Relative gel | Melting point | Gel hardness |
|---|---|---|---|
| Plant extract | content | after 14 days | after 14 days |
| Comparison sample | 100% | 44.6° C. | 884 g |
| without plant extract | | | |
| Tanal 04 | 100% | 53.7° C. | 999 g |
| Tanal 04 | 85% | 52.3° C. | 545 g |
| Tanal 04 | 75% | 51.3° C. | 503 g |
| Tanal 04 | 65% | 51.8° C. | 187 g |

These values reveal that the increase in the melting point of the gelatin gel brought about by the polyphenols had only a low dependency on the gelatin concentration and, even in a cross-linked gelatin gel with a gelatin content reduced to 65% relative to the comparison sample, a marked melting point increase was still achieved.

By contrast, as expected, the gel hardness was very dependent on the gelatin concentration and even with a reduction in the relative gelatin content to 85% of the comparison sample, the hardness loss could no longer be compensated for by adding the plant extract. By interpolating the values given, it can be estimated that a gelatin gel cross-linked with polyphenol and having a gelatin content reduced by approximately 4% (that is, a relative proportion of 96%) would have a similar gel hardness to that of the comparison sample.

### EXAMPLE 6

In this example, the effects of different concentrations of plant extract on the melting point increase of the gelatin gel were investigated.

The gum sweets were produced according to Example 2 and the mixing ratio between the first and second aqueous solutions was varied for the different samples. The melting points of the gelatin gel were measured after one day and after nine days following production of the gum sweets and are shown in Table 8 below:

TABLE 8

| | | Plant extract | Melting | Melting |
|---|---|---|---|---|
| | Mixing | relative to | point after | point after |
| Plant extract | ratio | gelatin | 1 day | 9 days |
| Comparison sample | — | 0 | 44.6° C. | 44.6° C. |
| without plant extract | | | | |
| Tanal 04 | 79:1 | 0.88% by | 48.2° C. | 51.8° C. |
| | | weight | | |
| Tanal 04 | 39:1 | 1.83% by | 47.9° C. | 53.7° C. |
| | | weight | | |
| Tanal 04 | 26:1 | 2.78% by | 52.2° C. | 52.3° C. |
| | | weight | | |
| Tanal 04 | 19:1 | 3.76% by | 51.7° C. | 52.8° C. |
| | | weight | | |

This reveals the tendency that, with the measurement after nine days and with a plant extract content of just 1.83% by weight relative to the quantity of gelatin, a very marked melting point increase is achieved which cannot be raised further by a further increase in the proportion of plant extract. A comparison of the values after one day shows, however, that the melting point increase achievable by means of a higher concentration of plant extract can, to some extent, be achieved more rapidly.

1. A sugar confectionary product comprising a gelatin gel, wherein the gelatin gel comprises approximately 1% to approximately 15% by weight of gelatin and approximately 20% to approximately 85% by weight of at least one sugar and/or sugar substitute, and wherein the sugar confectionary product comprises one or more polyphenols.

2. The sugar confectionary product according to claim 1, wherein the polyphenal or polyphenols are obtained from plant extracts and/or the sugar confectionary product comprises the polyphenol or polyphenols as a component of one or more plant extracts.

3. The sugar confectionary product according to claim 2, wherein the sugar confectionary product comprises at least 0.05% by weight of one or more polyphenol-containing plant extracts, relative to the weight of the gelatin.

4. The sugar confectionary product according to claim 2, wherein the sugar confectionary product contains comprises up to 10% by weight of one or more polyphenol-containing plant extracts, relative to the weight of the gelatin.

5. The sugar confectionary product according to claim 1, wherein the plant extract or extracts are selected from tea extract, grape extract, oak bark extract, cocoa extract or mixtures thereof.

6. The sugar confectionary product according to claim 1, wherein the polyphenol or polyphenols are selected from tannins, catechins, anthocyanins and quercetin.

7. The sugar confectionary product according to claim 1, wherein the gelatin gel has a melting point of over 40° C.

8. The sugar confectionary product according to claim 1, wherein the at least one sugar is selected from sucrose, glucose, fructose, glucose syrup and mixtures thereof.

9. The sugar confectionary product according to claim 1, wherein the sugar confectionary product is selected from the group consisting of gum sweets, marshmallows, chewing sweets, pastilles and liquorice.

10. A method for producing a sugar confectionary product according to claim 1, comprising:
producing a first aqueous solution which comprises the gelatin and optionally the at least one sugar and/or sugar substitute;
producing a second aqueous solution which comprises the polyphenol or polyphenols and optionally the at least one sugar and/or sugar substitute;
mixing the first and the second aqueous solutions at a temperature between approximately 60° C. and approximately 90° C., in order to obtain a moulding solution; and
moulding or extruding the moulding solution into a hollow mould which defines the shape of the sugar confectionary product.

11. The method according to claim 10, comprising mixing the first and second aqueous solutions is by a static mixer.

12. The method according to claim 10, wherein the second aqueous solution contains the at least one sugar and/or sugar substitute.

13. The method according to claim 10, wherein the first and second aqueous solutions are mixed in a ratio of approximately 1:1 to approximately 100:1.

14. The method according to claim 10, wherein the first aqueous solution contains approximately 1% to approximately 20% by weight of gelatin.

15. The method according to claim 10, wherein the second aqueous solution contains approximately 0.5% to approximately 25% by weight of one or more polyphenol-containing plant extracts.

16. The method according to claim 10, wherein the moulding solution is foamed before and/or during the moulding.

17. The sugar confectionary product according to claim 3, wherein the sugar confectionary product comprises at least 0.1% by weight of one or more polyphenol-containing plant extracts, relative to the weight of the gelatin.

18. The sugar confectionary product according to claim 4, wherein the sugar confectionary product comprises up to 5% by weight of one or more polyphenol-containing plant extracts, relative to the weight of the gelatin.

19. The sugar confectionary product according to claim 7, wherein the gelatin gel has a melting point of over 50° C.

20. The method according to claim 13, wherein the first and second aqueous solutions are mixed in a ratio of approximately 1:1 to approximately 50:1.
